(19) United States
(12) Patent Application Publication
(10) Pub. No.: US 2026/0097683 A1
(43) Pub. Date: Apr. 9, 2026

(54) BMS HARD REBOOT FUNCTION

(71) Applicant: Our Next Energy, Inc., Novi, MI (US)

(72) Inventors: Krzysztof Klesyk, Novi, MI (US); Yingying Gui, Novi, MI (US); Yan Zhou, Canton, MI (US); Richard Hampo, Ann Arbor, MI (US)

(73) Assignee: Our Next Energy, Inc., Novi, MI (US)

(21) Appl. No.: 19/351,481

(22) Filed: Oct. 7, 2025

Related U.S. Application Data
(60) Provisional application No. 63/705,341, filed on Oct. 9, 2024.

(51) Int. Cl. B60L 58/10; B60L 3/00

(52) U.S. Cl. CPC B60L 58/10; B60L 3/0053

(57) ABSTRACT

A battery system for an electric vehicle includes a high voltage battery, contactors connecting terminals of the high voltage battery to high voltage buses, a vehicle ON/OFF switch, a low voltage battery, a battery management system (BMS) controlling the contactors, wherein the BMS is powered by the low voltage battery when the vehicle is switched OFF, a backup power supply (BPS) for powering the BMS when the vehicle is switched ON, a controller regulating power from the BPS to the BMS, a second switch for disconnecting the BPS from the BMS, and a service tool interface configured to interact with a service tool to operate the second switch.

### CROSS-REFERENCE TO RELATED APPLICATION

This application claims priority to U.S. Provisional Application No. 63/705,341, filed Oct. 9, 2024, which is incorporated herein by reference in its entirety.

### FIELD OF THE DISCLOSURE

This disclosure relates to battery systems for electric vehicles, and more particularly to safe control of power from a backup power supply to a battery management system.

### BACKGROUND OF THE DISCLOSURE

In the field of electrical vehicles, there is a need for improved battery systems that reduce or eliminate hazards associated with energization of a high voltage bus when the vehicle is switched off, especially during servicing of the vehicle. Accordingly, there is a need for devices that are capable of reliably disconnecting power from a backup power supply to a battery management system controlling contactors engaging the high voltage buses when the vehicle is switched OFF.

### SUMMARY OF THE DISCLOSURE

Disclosed is a battery management system (BMS) for an electric vehicle having mechanisms for reliably de-energizing a battery management system and disconnecting high voltage batteries from high voltage buses. The system includes a high voltage battery, a positive contactor electrically connecting a positive terminal of the high voltage battery to a positive high voltage bus, a negative contactor electrically connecting a negative terminal of the battery to a negative high voltage bus, an ON/OFF switch for the vehicle, a low voltage battery, a battery management system (BMS) controlling the contactors, the BMS powered by the low voltage battery when the ON/OFF switch is ON, a backup power supply (BPS) for powering the BMS when the ON/OFF switch is OFF, a controller managing power from the BPS to the BMS, a second switch for disconnecting the backup power from the BMS, and a service tool interface configured to interact with a service tool to operate the second switch.

### BRIEF DESCRIPTION OF THE DRAWINGS

FIG. 1 schematically illustrates a battery system for an electric vehicle without a mechanism for reliably de-energizing a battery management system.

FIG. 2 schematically illustrates a battery system for an electric vehicle equipped with devices for safely and reliably de-energizing a battery management system.

### DETAILED DESCRIPTION

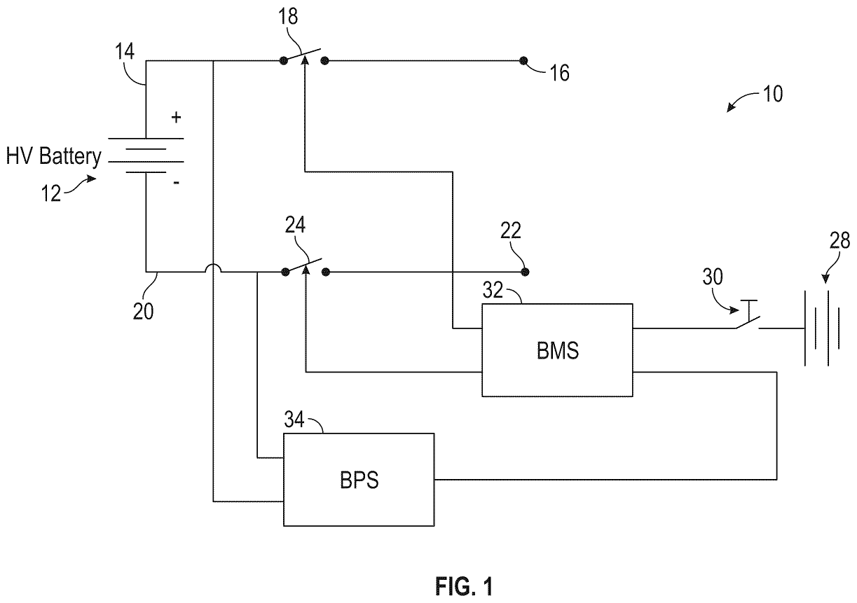

Shown in FIG. 1 is a schematic diagram showing a battery management system without means for reliably disconnecting a battery management system for controlling energization of high voltage buses from a backup power supply. The system 10 includes a first (high voltage, typically several hundred volts) battery 12 that has a positive terminal 14 electrically connected to a positive high voltage bus 16 when contactor 18 is closed and a negative terminal 20 electrically connected to a negative high voltage bus 22 when contactor 24 is closed. A battery management system 32 (BMS) controls contactors 18 and 24 to selectively supply power to and remove power from one or more electric motors, motor control units, and/or other high voltage loads connected to the high voltage buses. The BMS is normally powered by a low voltage battery 28 (e.g., typically less than 50 volts) when a vehicle ON/OFF switch 30 is switched to the ON (closed) position. A backup power supply 34 (BPS) provides power to the BMS as needed or in accordance with a predetermined schedule when switch 30 is in the OFF (open) position.

The BPS can be operated in either of a first mode in which a controller periodically (i.e., in accordance with a predetermined schedule) supplies power to the BMS while switch 30 is in the OFF position or a second mode in which the controller otherwise commands powering of the BMS.

A problem with battery system 10 (FIG. 1) is that in the event of a controller malfunction, BPS 34 may continuously supply power to BMS 32 for an indefinite period. Such inability to de-energize the BMS and open contactors 18 and 24 can pose a significant safety concern, particularly during car servicing when technicians need access to high voltage battery 12.

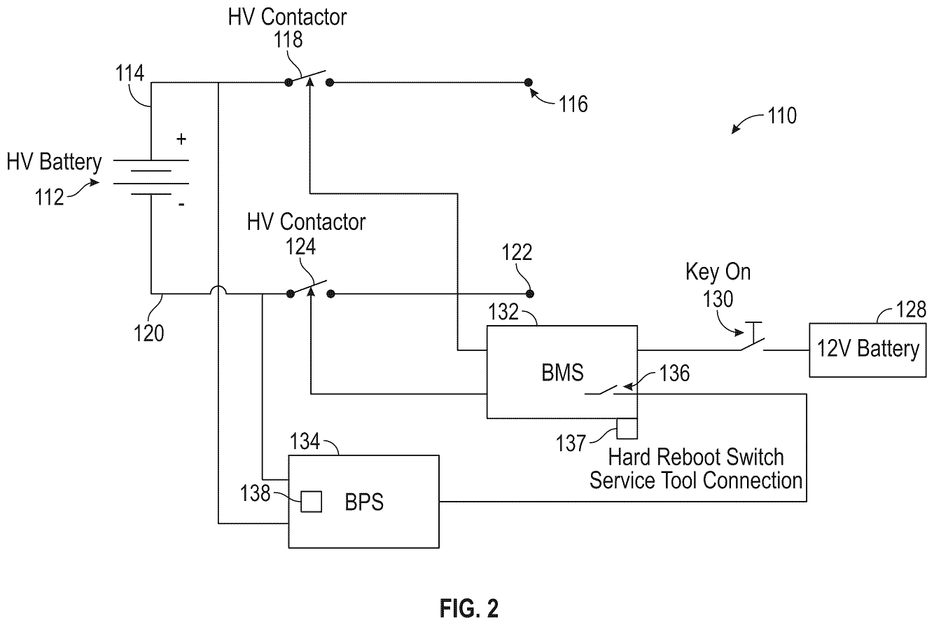

FIG. 2 is a schematic diagram showing a battery management system 110 having a switch control unit and a service tool configured to interact with an interface to operate a switch that reliably disconnects and removes power from a BPS to a BMS. System 110 includes first battery 112, having terminals 114 and 120 supplying power to buses 116 and 122 when contactors 118 and 124 are closed, a BMS 132, a BPS 134, a low voltage (e.g., 12 volts) battery 128, and a switch 130, all of which are analogous or identical to the corresponding components of system 10 in FIG. 1.

Additionally, system 110 includes a second switch 136 for disconnecting power from BPS 134 to BMS 132, and a service tool interface 137 configured to interact with a service tool to operate switch 136. A controller 138 is configured to selectively supply power to the BMS from the BPS when switch 130 is in the OFF position. Controller 138 is shown as an internal component of BPS 134 in FIG. 2. Controller 138 can be configured to receive external circuit inputs to detect and/or verify a malfunction and turn off (open) switch 136. However, it should be appreciated that there are not any significant constraints on the physical location of controller 138 in an electric vehicle (EV).

In the case of controller malfunction and/or for vehicle servicing, a service tool (not illustrated) can be connected or otherwise interact with service tool interface 137 to open switch 136 and thereby prevent power from being supplied by BPS 134 to BMS 136.

In some embodiments, system 110 can be configured such that when the service tool is connected with interface 137, the input port to BMS 132 sees an abnormally low voltage (e.g., 2 volts), with a Wake signal and/or high voltage interlock loop operating outside of a normal operating voltage range, causing a system fault that can be detected to turn off (open) switch 136 to complete a hard reboot.

The service tool can be any device capable of interacting with the service tool interface. The interaction can be mechanical, electrical, electromagnetic or electromechanical. Preferably, the service tool is configured to prevent or discourage interaction initiated by non-technicians. For example, the service tool interface can be a mechanical interface that is designed to interact with a tamper-resistant driver that limits user-initiated interaction based on non-commonality (i.e., general unavailability) of the required driver. Examples include service tool interfaces configured for engagement with a spanner driver, a security torx interface, a tri-angle interface, a tri-point interface, etc. Electromagnetic devices such as a Radiofrequency Identification (RFID) tag and an RFID reader can be employed, or an electronic key (e.g., similar to a remote garage door opener). As another example, an electronic lock interface in which an electronic drive physically engages an interface to trigger or cut-off power supplied to a mechanism that adjusts the ON/OFF position of the second switch.

The first battery 112 is a high voltage battery having an electrical potential difference of more than 60 volts, typically 400 volts or 800 volts. The second battery 128 is a low voltage battery having an electrical potential difference less than 60 volts, typically 12 volts (although 24 and 48 volt batteries are sometimes used).

Switch 130 can be any type of vehicle ignition (power ON/OFF) switch such as a key-operated switch, which can rely on tumblers and a uniquely shaped key capable of engaging the tumblers to operate the switch. Alternatively, switch 130 can be a push button, a key fob, or other device.

BPS 134 typically is or includes a DC-DC converter to reduce the high voltage from battery 112 to a low voltage suitable for powering BMS 132.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

1. A battery system for a vehicle, comprising:
a first battery having a first voltage;
a positive contactor electrically connecting a positive terminal of the first battery to a positive high voltage bus;
a negative contactor electrically connecting a negative terminal of the first battery to a negative high voltage bus;
a first switch for turning the vehicle ON and OFF;
a second battery having a second voltage that is lower than the first voltage;
a battery management system controlling the positive contactor and the negative contactor, the battery management system powered by the second battery when the first switch turns the vehicle ON;
a backup power supply for powering the battery management system when the first switch turns the vehicle OFF;
a controller configured to selectively supply power to the battery management system from the backup power supply when the first switch turns the vehicle OFF;
a second switch for disconnecting the backup power from the battery management system; and
a service tool interface configured to interact with a service tool to operate the second switch.

2. The battery system of claim 1, wherein the first battery has a voltage greater than 60 volts.

3. The battery system of claim 1, wherein the first battery has a voltage of at least 400 volts.

4. The battery system of claim 1, wherein the second battery has a voltage less than 60 volts.

5. The battery system of claim 1, wherein the second battery has a voltage of 12 volts.

6. The battery system of claim 1, wherein the first switch is a key-operated switch.

7. The battery system of claim 1, including a push-button to activate the first switch.

8. The battery system of claim 1, wherein the backup power supply includes a DC-DC converter for converting a voltage from input from the first battery to a lower voltage suitable for powering the battery management system.
